(19) United States
(12) Patent Application Publication
(10) Pub. No.: US 2012/0305841 A1
(43) Pub. Date: Dec. 6, 2012

(54) Bleach Tablet

(76) Inventor: Ali Almasri, Tupelo, MS (US)

(21) Appl. No.: 13/485,328

(22) Filed: May 31, 2012

Related U.S. Application Data
(60) Provisional application No. 61/519,792, filed on May 31, 2011.

(51) Int. Cl. C11D 7/54; C11D 11/00

(52) U.S. Cl. 252/186.37; 252/186.36; 264/128

(57) ABSTRACT

A method of making a bleach tablet includes mixing ingredients by weight that include 35 to 85% hypochlorite calcium/sodium, 0 to 80% bleach activator, 1 to 50% layered silicate and/or alkali metal silicate, 0 to 25% sodium/potassium bicarbonate, 5 to 45% by weight sodium dichloroisocyanurate, 0 to 5% disintegrating agent, 0 to 10% polymer, and 0 to 2% improvement additives; adding a builder compound to the mixed ingredients in an amount from 1% to 80% by weight; compressing the mixed ingredients to form the bleach tablet; and spraying a binder on the bleach tablet.

### CROSS REFERENCE TO RELATED APPLICATIONS

This utility patent application claims priority to U.S. provisional patent application Ser. No. 61/519,792 filed on May 31, 2011, which is incorporated by reference herein.

### TECHNICAL FIELD

The field of the invention relates to bleach products for laundry use.

### BACKGROUND

In one general aspect, a method of making a bleach tablet includes mixing ingredients by weight that include 35 to 85% hypochlorite calcium/sodium, 0 to 80% bleach activator, 1 to 50% layered silicate and/or alkali metal silicate, 0 to 25% sodium/potassium bicarbonate, 5 to 45% by weight sodium dichloroisocyanurate, 0 to 5% disintegrating agent, 0 to 10% polymer, and 0 to 2% improvement additives; adding a builder compound to the mixed ingredients in an amount from 1% to 80% by weight; compressing the mixed ingredients to form the bleach tablet; and spraying a binder on the bleach tablet.

Embodiments may include one or more of the following features. For example, mixing may include mixing by batch mixing in a concrete mixer, nauta mixer or ribbon mixer. Each component may be mixed by metering by weight on to a moving belt or screw conveyor, and blending the ingredients in one or more drum(s) or mixer(s). Mixing may also include mixing 0 to 5% by weight of a complex-binder.

Compressing may include forming the bleach tablet with a diameter of between 20mm and 60mm, and a weight between 2.5 and 10 g; the ratio of height to diameter (or width) of the tablets greater than 1:5. The equipment for compressing may include a standard single stroke or a rotary press, such as, for example, a Courtoy, Korch, Manesty, or Bonals press.

The bleach tablets may be packaged in a continuous layer having a moisture vapor transmission rate of the layer with less than 0 to 1 ml of H₂O/m2/day. The packaging further comprises micro-holes to decouple the ingress of moisture and facilitate evacuation of gas.

The builder compound that is added may be from 10% to 70% or 20% to 60% by weight of the mixed ingredients.

The compaction pressure of compression process may be between 1000 to 5000 kN/m and may utilize a compacting process, such as tableting, briquetting, or extrusion.

In another general aspect, a bleach table includes 35 to 85% hypochlorite calcium/sodium; 0 to 80% bleach activator; 1 to 50% layered silicate and/or alkali metal silicate; 0 to 25% sodium/potassium carbonate; 5 to 45% by weight sodium dichloroisocyanurate; 0 to 5% disintegrating agent; 0 to 10% polymer; 1% to 80% builder compound; and a binder applied to a surface of the bleach tablet.

Embodiments may include one or more of the above or the following feature. For example, the bleach tablet may contain 0 to 2% by weight improvement additives.

The bleach tablet of the present invention has several advantages:

Converting the usage of plastic gallons of liquid bleach to tableting formulated bleach for the fabric laundry and any other kind of bleach usage;

Eliminate the hazardous associated with liquid bleach, from discoloring clothes;

Strong odor of chlorine affecting people with breathing problems (asthmatics);

Eliminate the reaction with other dangerous liquid chemicals like ammonia for example;

Eliminate big space shelving needs in the house, supermarkets and warehouses;

Reduce dramatically the cost of trucking and shipping freight, since 90% of the liquid bleach is water; and

Eliminate the need for recycling millions of large plastic jugs and bottle containers.

### DESCRIPTION OF THE DRAWING

FIG. 1 illustrates a process of producing a bleach tablet.

### DETAILED DESCRIPTION

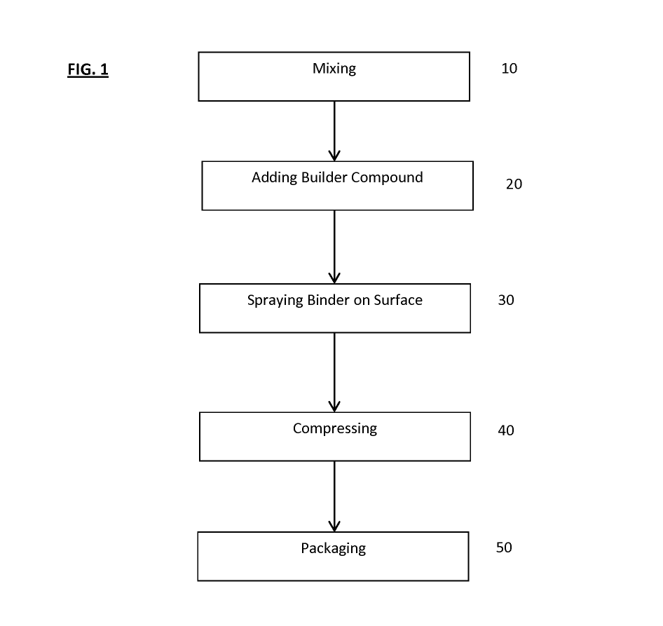

Referring to FIG. 1, a method of making a bleach table includes mixing a composition of active ingredients in operation 10, adding a builder compound to the mixed ingredients in operation 20, compressing the mixed ingredients to form the bleach tablet in operation 30, spraying a binder on the surface of the table in operation 40 and packaging the bleach tablets in operation 50. The composition of the present invention comprises at least one bleaching agent. Preferably the composition comprises at least two or more bleaching agents. The total active bleaching agent concentration is preferably from 1% to 80% by weight, more preferably from 10% to 70% by weight, most preferably from 20% to 60% by weight of the composition. Suitable bleaching agents are selected from Oxygenated haloginic and non haloginic components.

Compositions herein can also be used as bleach additive products. Such additive products are intended to supplement or boost the performance of conventional detergent with bleach compositions and can be added at any stage of the cleaning process.

The bleach tablets of the present invention are made by tableting a bleaching base powder. The base powder is typically a pre-formed bleach granule. The pre-formed bleach granule may be an agglomerated particle or in any other form. The average particle size of the base powder is typically from 100 μm to 2,000 μm, preferably from 200 μm, or from 300 μm, or from 400 μm, or from 500 μm and preferably to 1,800 μm, or to 1,500 μm, or to 1,200 μm, or to 1,000 μm, or to 800 μm, or to 700 μm. Most preferably, the average particle size of the base powder is from 400 μm to 700 μm. The bulk density of the base powder is typically from 400 g/l to 1,200 g/l, preferably from 500 g/l to 950 g/l, more preferably from 600 g/l to 900 g/l, and most preferably from 650 g/l to 850 g/l.

Bleach tablets may have the following percentages of additives: 35 to 85% by weight based on the original concentrations for the active chlorine in the calcium hypochlorite or sodium hypochlorite, 0 to 80% by weight bleach activator calculated as TAED, 1 to 50% by weight layered silicate and/or alkali metal silicate, 0 to 25% by weight sodium/potassium carbonate, 0 to 25% by weight sodium/potassium bicarbonate, (15 to 75% Sodium thiosulfate Na₂S₂O₃ for bleach alternatively tablets), 5 to 45% by weight sodium dichloroisocyanurate, 0 to 5% by weight complex-binder, 0 to 5% by weight disintegrating agent, 0 to 10% by weight polymer and 0 to 2% improvement additives (coloring, perfumes, etc.).

The bleach tablets are intended for use together with usual fabric detergent compositions and display a good storage stability and good tablet-technical properties, such as rate of dissolution and tablet strength, and they are very environmentally desirable.

Particles of the present invention have sufficient hardness to survive handling and transportation, will rapidly dissolve in water during a short cycle washing and/or rinsing process without leaving residue.

The bleach tablets of the present invention are made using known techniques for making tablets. The tablets are made from compressed particles, granules or powders. The tablets may comprise one or more different regions. Providing different regions allows the manufacturer to include chemically or physically reactive ingredients in the tablet formulations but in different regions so as to reduce or eliminate any disadvantageous interactions.

The different regions can either have the same or different colors. Multi-layer tablets having 2 or 3 layers are preferred. Single and multi-layer tablets having excavations and/or cavities and/or holes in all sorts of geometrical forms are also included in the present invention. Particularly preferred are tablets in which embedded geometrical shapes such as hemispheres protrude from the surface of the tablet, and standard flat surface round tablet.

When formulated in a laundry bleach tablet, the composition herein preferably comprises a builder compound, typically present at a level of from 1% to 80% by weight, preferably from 10% to 70% by weight, most preferably from 20% to 60% by weight of the composition.

Highly preferred builder compounds for use in the present invention are water-soluble carbonates builders. Specific examples of water-soluble carbonates builders are the alkali metal carbonate and bicarbonates, sodium, potassium, and calcium, sodium polymeta/phosphate in which the degree of polymerization ranges from 6 to 21, and salts of phytic acid.

The bleach tablets of the present invention can be dosed to the laundry machine via the drawer or directly into the drum, potentially via a dispensing device, such as a net.

Tablets can be prepared simply by mixing the solid ingredients together and compressing the mixture in a conventional tablet press as used, for example, in the pharmaceutical industry, in the food industry, or in the detergent industry. The detergent tablets can be made in any size or shape and can, if desired, be coated. The particulate materials used for making the tablet can be made by any particulation or granulation process.

The particulate materials may be mixed together by any conventional means. Batch is suitable in, for example, a concrete mixer, Nauta mixer, ribbon mixer or any other. Alternatively the mixing process may be carried out continuously by metering each component by weight on to a moving belt or screw conveyor, and blending them in one or more drum(s) or mixer(s). A binder, preferably a non-gelling binder; can be sprayed on to the mix of some, or, on the mix of all of the particulate materials, either separately or premixed. For example perfume and slurries of optical brighteners may be sprayed. A finely divided flow aid (dusting agent such as zeolites, carbonates, silicas) can be added to the particulate materials after spraying the binder, preferably towards the end of the process, to make the mix less sticky.

The tablets may be manufactured by using any compacting process, such as tableting, briquetting, or extrusion, preferably tableting. Suitable equipment includes a standard single stroke or a rotary press (such as Courtoy, Korch, Manesty, or Bonals). Tablets prepared should preferably have a diameter of between 20 mm and 60 mm, and a weight between 2.5 and 10 g. The ratio of height to diameter (or width) of the tablets is preferably greater than 1:5, more preferably greater than 1:4. The compaction pressure used for preparing these tablets need not exceed 5000 kN/m, preferably not exceed 3000 kN/m, and most preferably not exceed 1000 kN/m.

Preferably the bleach tablet of the present invention will be packaged into a humidity resistant package. It has been found that the long term stability of the tablet will be further improved by packaging the tablets with materials that provide a moisture barrier, expressed as a moisture vapor transmission rate (MVTR), of at less than 1 g H₂O/day/m2, preferably less than 0.1 g H₂O/day/m2, and more preferably less than 0.02 g H₂O/day/m2.

The choice of packaging material for the bleach tablet of the present invention can be determined by following several steps. First, determine the critical amount of water that can be adsorbed or absorbed by the bleach tablet without losing performance, where the loss of performance can be quantified by the level of bleach components in the head space above or on the dried fabrics, by the incomplete dissolution of the composition/article, etc. Water absorption may be determined by exposing the composition/article to constant humidity and determining the mass gained over time. Then, evaluate the performance (analytical and/or sensory) of each bleach tablet to determine the critical quantity of water. Second, determine the surface area of the package in which the bleach tablets will be packaged and sold in the trade. Third, determine the in-trade stability requirement, such as the number of months that the bleach tablet is likely to remain in the package prior to use. The maximum moisture vapor transmission rate (MVTR) for the detergent tablet may be calculated using the following equation:

MVTR=(Critical Mass of Water)/(Surface Area of Package)/(in-trade stability required)[=]1 g H₂O/m2/day.

Tabulated values of MVTR provided in technical references generally report data determined at 28-38° C., and 80%-90% relative humidity such that they represent worst case scenario ambient conditions. Selecting the packaging material under these conditions will ensure long term stability of the article. Preferably, the article is packaged so that moisture penetration must occur through a continuous layer, and the moisture vapor transmission rate of the layer is less than 1 g H₂O/m2/day, preferably less than 0.5 g H₂O/m2/day, more preferably less than 0.1 g H₂O/m2/day, even more preferably less than 0.02 g H₂O/m2/day and still more preferably 0 g H₂O/m2/day, to ensure article stability.

The packaging system comprises at least a micro-hole. There may also be more than 1 micro-hole. These can be made using a pin. An advantage of using a micro-hole in combination of a material having the claimed MVTR is that the problem of ingress of moisture and the problem of evacuation of gas can be decoupled. Indeed the ingress of moisture is readily controlled by choosing the right MVTR, whereas a micro-hole has only a negligible influence on ingress of moisture because it is present only at some points on the packaging system without modifying the characteristics of the remaining surface of the packaging system and a micro hole will not have influence enough if there is no pressure gradient. As a pressure gradient will appear precisely when gas needs to be evacuated to prevent deformation of the packaging system the micro-hole will fulfill its function without significant influence on the ingress of moisture. The tablets of the invention can be sealed after being deposed onto the blister thermoforming packaging system. A seal or an adhesive is particularly suited to the packaging system of the present invention. Indeed may be applied to the surface of the thermoforming blister packaging system.

The following claims represent examples of compositions according to the present invention. The compositions are then tableted and packed. They are not meant to be limiting of the scope of the invention.

In another embodiment, the tablets may include detergents such as anionic and non anionic surfactants to produce laundry detergent tables. Stain removers may also be added to the tablets to product a detergent/stain remover/bleach tablet.

1. A method of making a bleach tablet, comprising the steps of:
mixing ingredients by weight that include 35 to 85% hypochlorite calcium/sodium, 0 to 80% bleach activator, 1 to 50% layered silicate and/or alkali metal silicate, 0 to 25% sodium/potassium bicarbonate, 5 to 45% by weight sodium dichloroisocyanurate, 0 to 5% disintegrating agent, 0 to 10% polymer, and 0 to 2% improvement additives;
adding a builder compound to the mixed ingredients in an amount from 1% to 80% by weight;
compressing the mixed ingredients to form the bleach tablet; and
spraying a binder on the bleach tablet.

2. The method of claim 1, wherein the mixing comprises mixing by batch mixing in a concrete mixer, nauta mixer or ribbon mixer.

3. The method of claim 1, wherein the mixing comprises metering each component by weight on to a moving belt or screw conveyor, and blending the ingredients in one or more drum(s) or mixer(s).

4. The method of claim 1, wherein the mixing further comprises mixing 0 to 5% by weight of a complex-binder.

5. The method of claim 1, wherein compressing comprises forming the bleach tablet with a diameter of between 20 mm and 60 mm, and a weight between 2.5 and 10 g; the ratio of height to diameter (or width) of the tablets greater than 1:5.

6. The method of claim 1, wherein the compressing includes compressing with equipment that includes a standard single stroke or a rotary press.

7. The method of claim 6, wherein the press comprises a Courtoy, Korch, Manesty, or Bonals press.

8. The method of claim 1, further comprising:
packaging the bleach tablets with a continuous layer having a moisture vapor transmission rate of the layer with less than 0 to 1 ml of H₂O/m2/day.

9. The method of claim 1, wherein the packaging further comprises micro-holes to decouple the ingress of moisture and facilitate evacuation of gas.

10. The method of claim 1, wherein adding the builder compound comprises adding a builder compound from 10% to 70% by weight of the mixed ingredients.

11. The method of claim 1, wherein adding the builder compound comprises adding a builder compound from 20% to 60% by weight of the mixed ingredients.

12. The method of claim 1, wherein compressing includes a compaction pressure of between 1000 to 5000 kN/m.

13. The method of claim 1, wherein compressing includes a compacting process, such as tableting, briquetting, or extrusion.

14. A bleach tablet, comprising:
35 to 85% hypochlorite calcium/sodium;
0 to 80% bleach activator;
1 to 50% layered silicate and/or alkali metal silicate;
0 to 25% sodium/potassium carbonate;
5 to 45% by weight sodium dichloroisocyanurate;
0 to 5% disintegrating agent;
0 to 10% polymer;
1% to 80% builder compound; and
a binder applied to a surface of the bleach tablet.

15. The bleach table of claim 14, further comprising:
0 to 2% improvement additives.
